(19) United States
(12) Patent Application Publication
(10) Pub. No.: US 2025/0253382 A1
(43) Pub. Date: Aug. 7, 2025

(54) Battery End Plate of a Battery

(71) Applicant: East Penn Manufacturing Co., Lyon Station, PA (US)

(72) Inventors: Thomas A. Faust, JR., Oley, PA (US); Stephen K. Fairchild, Kutztown, PA (US); Ricardo Juarez Favila, West Reading, PA (US)

(73) Assignee: East Penn Manufacturing Co., Lyon Station, PA (US)

(21) Appl. No.: 18/435,162

(22) Filed: Feb. 7, 2024

(51) Int. Cl. H01M 10/04; H01M 50/148; H01M 50/188; H01M 50/533; H01M 50/55; H01M 50/552; H01M 50/566

(52) U.S. Cl. CPC H01M 10/0418; H01M 50/148; H01M 50/188; H01M 50/533; H01M 50/55; H01M 50/552; H01M 50/566

(57) ABSTRACT

A battery end plate includes a cap, a current collector, and a terminal. The cap has an interior face, an exterior face opposite the interior face, and a top side extending between the interior face and the exterior face. A passageway extends in a vertical direction into the top side and a slot extends in a longitudinal direction perpendicular to the vertical direction into the interior face. The passageway communicates with the slot between the interior face and the exterior face. The current collector has a tab and is disposed on the interior face; the tab extends into the slot. The terminal is disposed in the passageway and is electrically connected with the tab of the current collector.

### FIELD OF THE INVENTION

The present invention relates to a battery end plate and, more particularly, to a battery end plate having a terminal connected to a current collector.

### BACKGROUND

Batteries, for example bipolar batteries, have a plurality of bipolar plates stacked and held between battery end plates. The battery end plates have a current collector and a terminal connected to the current collector that permits external electrical connection to the battery. In existing battery end plates, however, the connection between the current collector and the terminal can create issues with battery performance. The connection between the current collector and the terminal is often mechanically weak and subject to corrosion. Further, it is difficult to fully seal the connection point between the current collector and the terminal, potentially creating a leak path along which electrolyte can leak out of the battery.

### SUMMARY

A battery end plate includes a cap, a current collector, and a terminal. The cap has an interior face, an exterior face opposite the interior face, and a top side extending between the interior face and the exterior face. A passageway extends in a vertical direction into the top side and a slot extends in a longitudinal direction perpendicular to the vertical direction into the interior face. The passageway communicates with the slot between the interior face and the exterior face. The current collector has a tab and is disposed on the interior face; the tab extends into the slot. The terminal is disposed in the passageway and is electrically connected with the tab of the current collector.

### BRIEF DESCRIPTION OF THE DRAWINGS

The invention will now be described by way of example with reference to the accompanying figures, of which:

FIG. 1 is an exploded perspective view of a battery according to an embodiment;

FIG. 2 is a perspective view of a battery end plate according to an embodiment;

FIG. 3 is a perspective view of a cap of the battery end plate of FIG. 2;

FIG. 4 is a perspective view of a current collector and a terminal of the battery end plate of FIG. 2;

FIG. 5 is a flowchart of a process of assembling the battery end plate of FIG. 2;

FIG. 6A is a sectional perspective view of the battery end plate of FIG. 2;

FIG. 6B is a detailed sectional side view of a portion 6B of FIG. 6A;

FIG. 7 is a perspective view of a current collector and a terminal of a battery end plate according to another embodiment;

FIG. 8A is a sectional perspective view of the battery end plate according to another embodiment; and

FIG. 8B is a detailed sectional side view of a portion 8B of FIG. 8A.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

Throughout the specification, directional descriptors are used such as “longitudinal”, “width”, and “vertical”. These descriptors are merely for clarity of the description and for differentiation of the various directions. These directional descriptors do not imply or require any particular orientation of the disclosed elements.

Throughout the drawings, only some of a plurality of identical elements may be labeled in a figure for clarity of the drawings, but the detailed description of the element herein applies equally to each of the identically appearing elements in the figure.

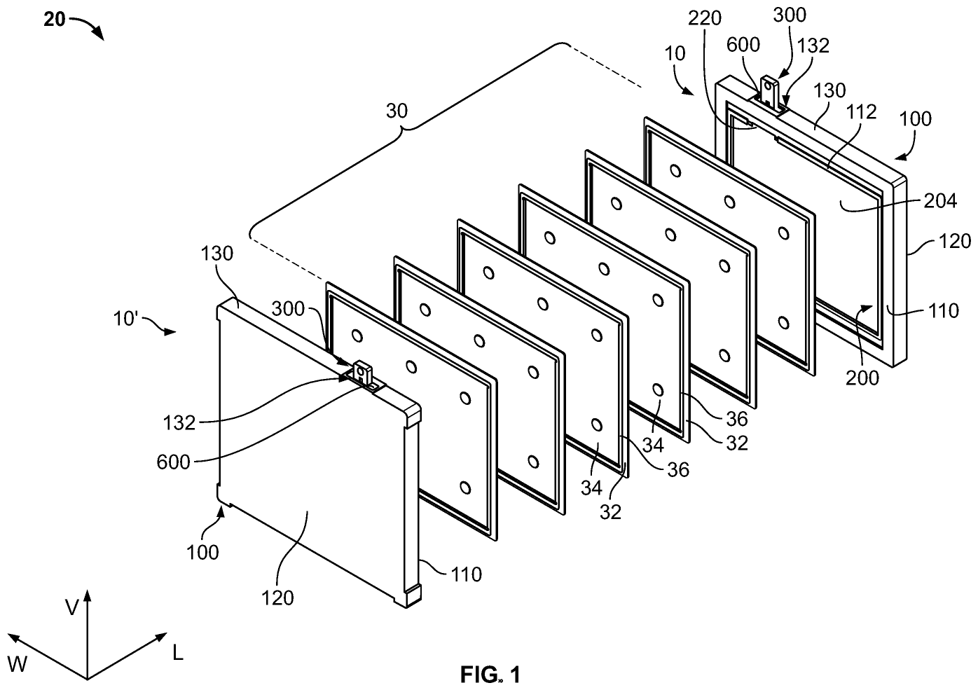

A battery 20 according to an embodiment is shown in FIG. 1. The battery 20 includes a pair of battery end plates 10, 10′ and a plurality of bipolar plates 30 disposed between the battery end plates 10, 10′. The battery end plates 10, 10′ will be described first in greater detail below. The battery end plates 10, 10′ are similar to one another; the description of the battery end plates 10, 10′ will focus on one battery end plate 10, but applies equally to both battery end plates 10, 10′ of the battery 20. The same reference numerals are used for the same elements of each of the battery end plates 10, 10′.

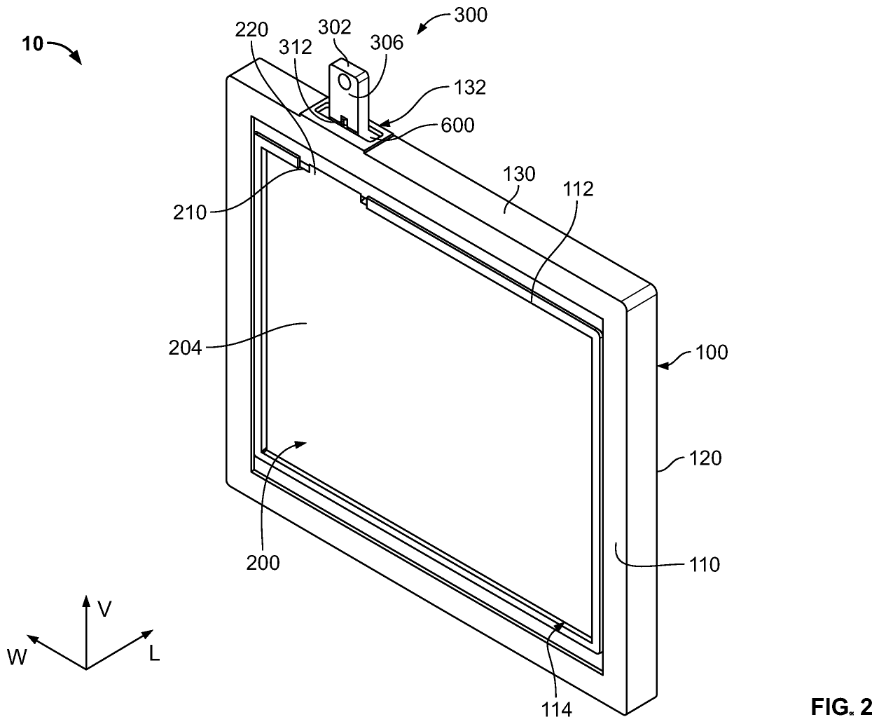

The battery end plate 10, as shown in FIGS. 1 and 2, includes a cap 100, a current collector 200 disposed on the cap 100, and a terminal 300 disposed in the cap 100 and connected to the current collector 200.

The cap 100, as shown in FIGS. 1-3, has an interior face 110 and an exterior face 120 opposite the interior face 110 in a longitudinal direction L. The interior face 110 has a cap alignment frame 114 that extends from the interior face 110 in a longitudinal direction L. The longitudinal direction L is normal to the interior face 110. The cap alignment frame 114 forms a substantially continuous perimeter on the interior face 110 and defines a collector recess 114 over the interior face 110.

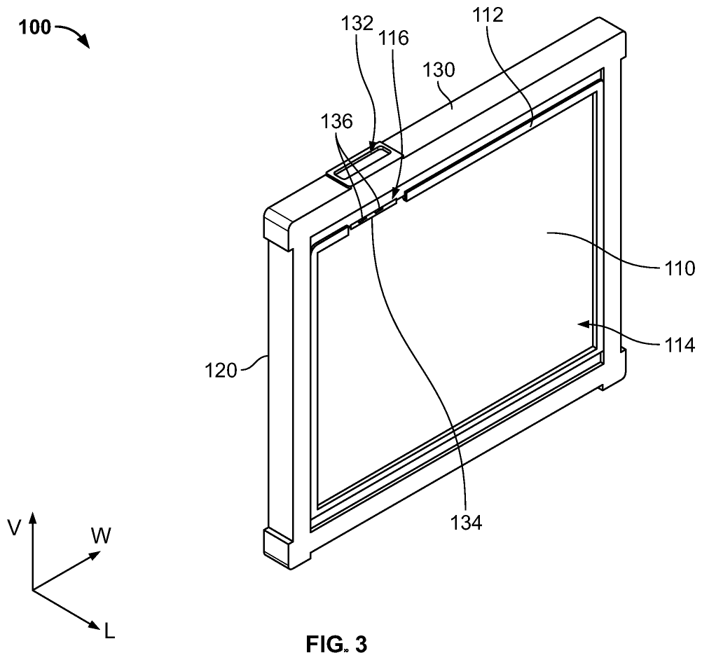

As shown in FIG. 3, the interior face 110 has a slot 116 extending into the interior face 110 in the longitudinal direction L. The slot 116 is positioned adjacent to a top side 130 of the cap 100 in a vertical direction V perpendicular to the longitudinal direction L. The slot 116, in the shown embodiment, interrupts the otherwise continuous perimeter of the cap alignment frame 114 and is positioned at an edge or side of the collector recess 114. In other embodiments, the slot 116 may be positioned elsewhere on the interior face 110 and does not necessarily interrupt the cap alignment frame 114, provided that it communicates with the passageway 132 as described elsewhere herein.

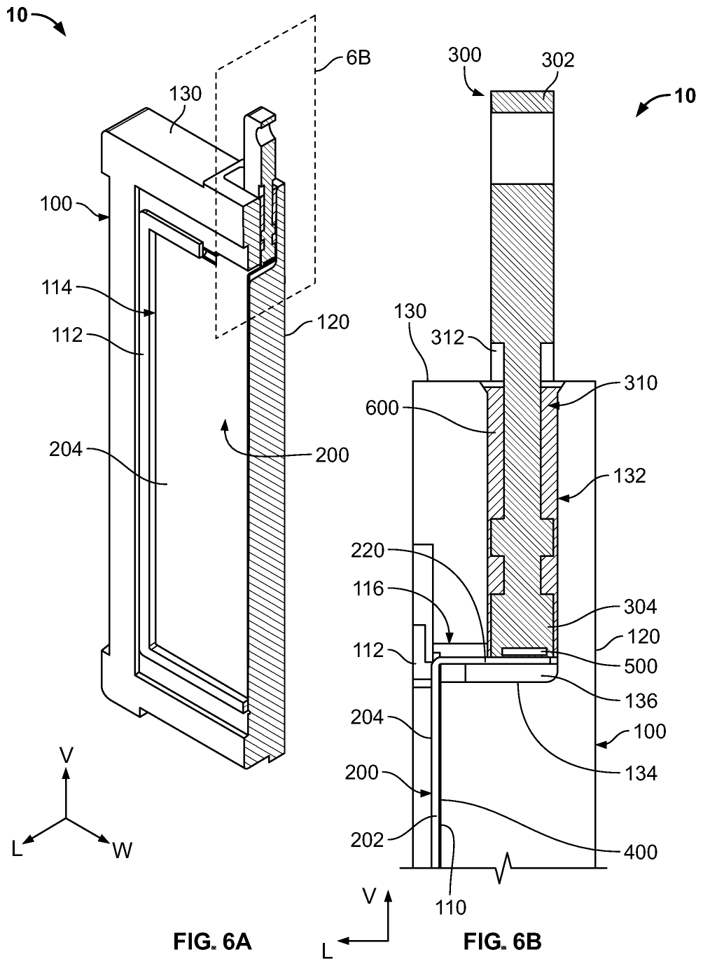

The top side 130 of the cap 100 extends between the interior face 110 and the exterior face 120. The cap 100 has a passageway 132 extending into the top side 130 of the cap 100 in the vertical direction V. The passageway 132 communicates with the slot 116, as shown in FIGS. 3 and 6B, between the interior face 110 and the exterior face 120. The passageway 132 has a bottom surface 134 that defines a bottom of the passageway 132 in the vertical direction V; the bottom surface 134 of the passageway 132 also forms a bottom surface of the slot 116.

The cap 100, as shown in FIGS. 3 and 6B, has a plurality of standoffs 136 positioned on the bottom surface 134 of the passageway 132. The standoffs 136 extend from the bottom surface 134 in the vertical direction V and are separated from one another in a width direction W perpendicular to the longitudinal direction L and the vertical direction V. In the shown embodiment, the cap 100 has two standoffs 136. In other embodiments, the cap 100 may have one standoff 136 or three or more standoffs 136.

The cap 100 is formed of a rigid plastic material. In the shown embodiment, the cap 100 is monolithically formed in a single piece, including with the cap alignment frame 112 and the standoffs 136. In another embodiment, the cap alignment frame 112 may be formed separately from the other elements of the cap 100 described above and may be attached to the interior face 110 of the cap 100.

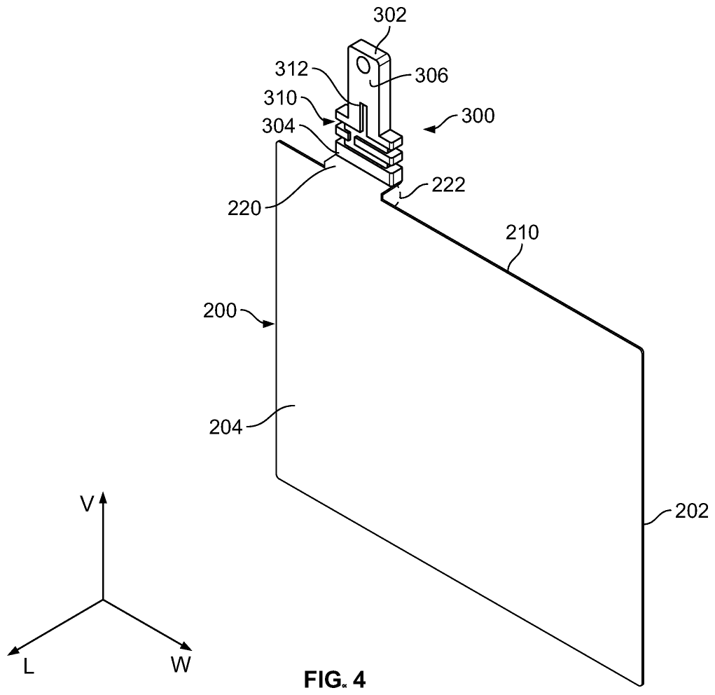

The current collector 200 of the battery end plate 10, as shown in FIG. 4, has a cap surface 202 and an active surface 204 opposite the cap surface 202 along the longitudinal direction L. The cap surface 202 and the active surface 204, in the shown embodiment, form a main body of the current collector 200 as a rectangular element. The current collector 200 has a top edge 210 of each of the cap surface 202 and the active surface 204, with a tab 220 extending from the top edge 210 at an angle 222 with respect to a remainder of the current collector 200. In the shown embodiment, the tab 220 extends in the longitudinal direction L, approximately at a right angle 222 from the current collector 200. The term “approximately” within the context of this specification is intended to mean within +/−10% of the described value.

The current collector 200 is formed of a conductive material and, in an embodiment, is formed of lead. The tab 220 is monolithically formed in a single piece with a remainder of the current collector 200 in the shown embodiment. In other embodiments, the tab 220 could be formed separately from the remainder of the current collector 200 and attached to the remainder of the current collector 200 in the orientation shown in FIG. 4.

The terminal 300, as shown in FIG. 4, has an exterior end 302 and a bottom end 304 opposite the exterior end 302 in the vertical direction V. The terminal 300 has a raceway 310 in an outer surface 306 of the terminal 300. The raceway 310, in the shown embodiment, is a series of grooves in the outer surface 306 that are interconnected and extend both around the terminal in the width direction W and along the terminal in the vertical direction V. The raceway 310 has an insertion end 312 at a highest point in the vertical direction V. The terminal 300 is monolithically formed in a single piece from a conductive material, for example brass.

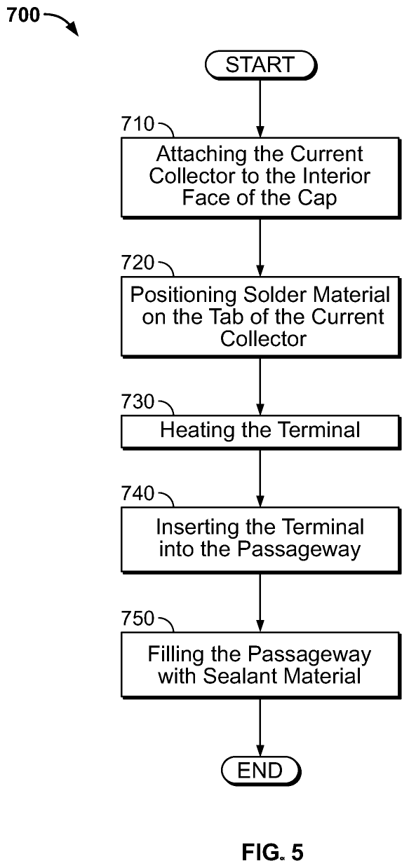

The assembly of the end plate 10 will now be described in greater detail, primarily with respect to FIGS. 5, 6A, and 6B. A process 700 of assembling the end plate 10 is shown in FIG. 5.

In a first step 710 of the process 700, the current collector 200 is attached to the cap 100. In this step 710, an adhesive material 400, shown in FIG. 6B, is applied to the cap surface 202 of the current collector 200 or to the interior face 110 of the cap 100. In an embodiment, the adhesive material 400 is a tape, such as a Very High Bond (VHB) tape. In other embodiments, the adhesive material 400 could be any other type of adhesive that is capable of being used in battery applications and providing the sealing function required by the design.

The cap surface 202 of the current collector 200 is pressed against the interior face 110 of the cap 100 in the first step 710 and the adhesive material 400 attaches the current collector 200 to the interior face 110 of the cap 100, a shown in FIGS. 2, 6A, and 6B. The adhesive material 400 and the current collector 200 are positioned on the interior face 110 within the collector recess 114 defined by the cap alignment frame 112. The cap alignment frame 112 extends beyond the current collector 200 in the longitudinal direction L. The adhesive material 400 forms a seal between the current collector 200 and the interior face 110 of the cap 100 that prevents corrosion of the current collector 200 by, for example, the permeation of corrosive materials such as battery electrolyte between the current collector 200 and the cap 100.

When the current collector 200 is disposed on and attached to the interior face 110, the tab 220 is positioned to extend into the slot 116 of the cap 100, as shown in FIGS. 2, 6A, and 6B. The tab 220, in the shown embodiment, is positioned on the standoffs 136 and spaced apart from the bottom surface 134 of the passageway 132 in the vertical direction V.

In a step 720, shown in FIG. 5, a solder material 500 is positioned in the passageway 132 of the cap 100 on the tab 220. The solder material 500, in an embodiment, is a preformed, prefluxed solder. The solder material 500 is in a solid form when positioned on the tab 220 in the passageway 132 in the step 720.

The terminal 300 is heated in a step 730 shown in FIG. 5. The terminal 300 is thermally conductive and increases in temperature when heated. The heating of the terminal 300 can be conducted by contact between the terminal 300 and a heating element, for example carbon probes or a resistive heating element, by inductive heating, or without direct contact between the terminal 300 and the heating element, for example via hot air.

In a step 740 shown in FIG. 5, the heated terminal 300 is inserted into the passageway 132. When the bottom end 304 of the terminal 300 contacts the solder material 500 on the tab 220 in the passageway 132, as shown in FIG. 6B, the temperature of the terminal 300 is sufficiently high to melt the solder material 500. The solder material 500 reflows along the tab 220 and the bottom end 304 of the terminal 300, solidifying as the terminal 300 and the solder material 500 cool to form a mechanical and electrical connection between the terminal 300 and the current collector 200 via the tab 220. The solidified solder material 500 is positioned in the passageway 132 between the terminal 300 and the tab 220, as shown in FIG. 6B.

As shown in FIGS. 2 and 6B, in the position in which it is connected to the tab 220 by the solder material 500, the terminal 300 has a portion of the raceway 310 positioned within the passageway 132 with the insertion end 312 of the raceway 310 exposed above the top side 130 of the cap 100. In the shown embodiment, the insertion end 312 of the raceway 310 is connected with the portion of the raceway 310 positioned within the passageway 132.

In a step 750 shown in FIG. 5, a sealant material 600 is filled in the passageway 132 between the terminal 300 and the cap 100, as shown in FIG. 6B. The sealant material 600, in an embodiment, is an epoxy. In other embodiments, the sealant material 600 may be any material used for providing an acid resistant and/or liquid tight seal to plastic and metal materials. The sealant material 600 is filled in the step 750 by inserting the sealant material 600, for example by injection with a syringe, into the insertion end 312 of the raceway 310 that is exposed above the top side 130 of the cap 100. The sealant material 600 is in a liquid state during insertion and flows along the raceway 310, filling all the grooves that form the raceway 310 and filling the space between the outer surface 306 of the terminal 300 and the surface of the cap 100 that defines the passageway 132. The sealant material 600 cures to the position shown in FIG. 6B to form a seal between the terminal 300 and the cap 100.

The battery end plate 10 assembled as described above is used as the battery end plates 10, 10′ in the battery 20 shown in FIG. 1. The battery end plates 10, 10′ form the ends of the battery with the bipolar plates 30 disposed between the battery end plates 10, 10′. As shown in FIG. 1, each of the bipolar plates 30 has a frame 32, a substrate 34 held within the frame 32, and a plate alignment element 36 extending from the frame 32.

When the battery 20 is assembled, each side of the substrate 34 and one or both sides of the frame 32 of each bipolar plate 30 may be covered with foil, and active material is positioned within the plate alignment element 36 on each side of the bipolar plate 30 over the foil. Likewise, the active surface 204 of the current collector 200 is covered with an active material within the cap alignment frame 112 on the interior face 110 of the cap 100. The bipolar plates 30 are then stacked and held between the battery end plates 10, 10′, with an electrolyte distributed between the battery end plates 10, 10′ and bipolar plates 30.

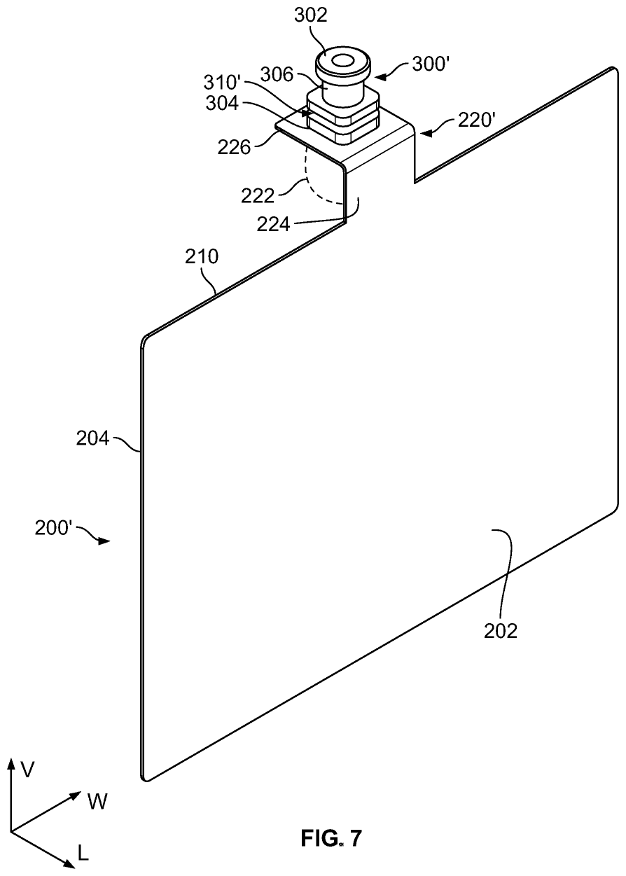

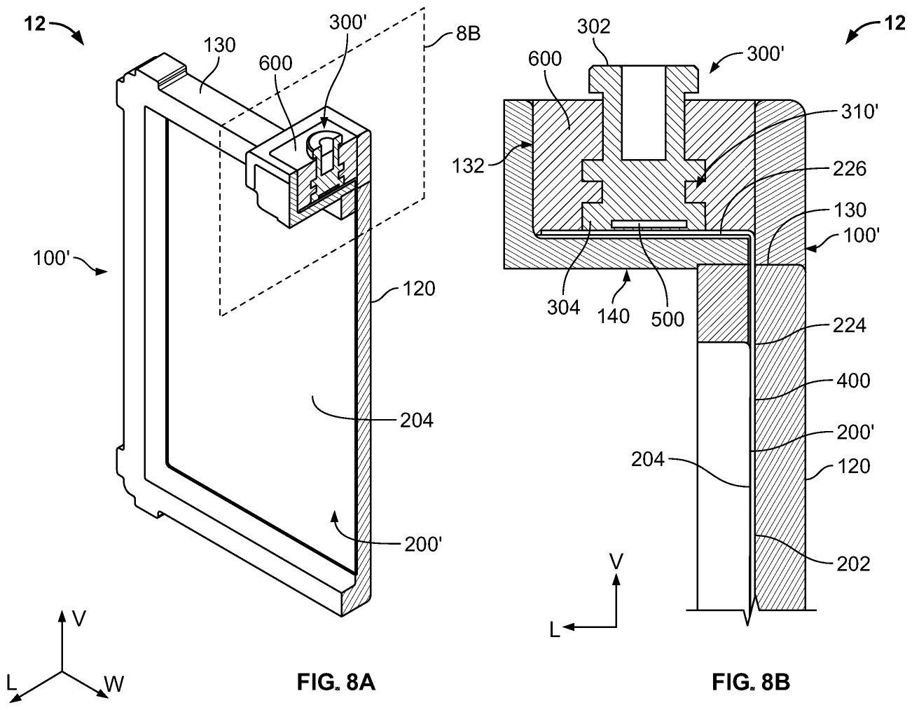

A battery end plate 12 according to another embodiment, including a cap 100′, a current collector 200′, and a terminal 300′ according to another embodiment, is shown in FIGS. 7, 8A, and 8B. Like reference numbers refer to like elements with respect to the embodiment shown in FIGS. 1-6B and described in detail above. The differences of the embodiment in FIGS. 7, 8A, and 8B will be primarily described in detail below.

As shown in FIG. 7, the tab 220′ of the current collector 200′ has a first portion 224 extending from the top edge 210 of the cap surface 202 and the active surface 204 and a second portion 226 that extends from the first portion 224. In this embodiment, the first portion 224 is parallel to the cap surface 202 and the active surface 204, and the second portion 226 of the tab 220′ extends at the angle 222 from the first portion 224.

The terminal 300′, as shown in FIG. 7, has a raceway 310′ in the outer surface 306, but the raceway 310′ in the embodiment is a single groove in the outer surface 306 of the terminal 300′. In the embodiment shown in FIG. 7, the raceway 310′ does not have an insertion end that extends in the vertical direction V as in the embodiment of FIG. 4.

In the embodiment of the battery end plate 12, the cap 100′ has a terminal housing 140 that extends from the top side 130 along the longitudinal direction L, as shown in FIG. 8B. In this embodiment, the passageway 132 is in the terminal housing 140 and has a larger dimension in the longitudinal direction L than in the embodiment of FIG. 6B; the passageway 132 has open space on both sides of the terminal 300′ when the terminal 300′ is positioned in the terminal housing 140.

The assembly of the battery end plate 12, resulting in the arrangement shown in FIGS. 8A and 8B, includes the steps of attaching the current collector 200′ to the cap 100′ with the adhesive material 400, positioning the second portion 226 of the tab 220′ in the passageway 132, heating the terminal 300′, and inserting the terminal 300′ into the passageway 132 to melt the solder material 500 and mechanically and electrically connect the terminal 300′ to the current collector 200′. In this embodiment, the sealant material 600 is then poured into the passageway 132 of the terminal housing 140 and fills both the raceway 310′ and the excess area between the terminal 300′ and the terminal housing 140.

In the battery end plates 10, 12 and the battery 20 described according to the above embodiments, the connection between the tab 220, 220′ of the current collector 200, 200′ and the terminal 300, 300′ within the passageway 132 of the cap 100, 100′ creates a strong mechanical and electrical bond using the solder material 500. The raceway 310, 310′ of the terminal 300, 300′ also allows the sealant material 600 to form a stronger seal between the terminal 300, 300′ and the cap 100, 100′, preventing leakage of electrolyte. Further, the use of the adhesive material 400 between the current collector 200, 200′ and the cap 100, 100′ prevents the electrolyte from entering between the current collector 200, 200′ and the cap 100, 100′, limiting a common source of corrosion.

What is claimed is:

1. A battery end plate, comprising:
a cap having an interior face, an exterior face opposite the interior face, and a top side extending between the interior face and the exterior face, a passageway extends in a vertical direction into the top side, a slot extends in a longitudinal direction perpendicular to the vertical direction into the interior face, the passageway communicates with the slot between the interior face and the exterior face;
a current collector having a tab, the current collector is disposed on the interior face and the tab extends into the slot; and
a terminal disposed in the passageway and electrically connected with the tab of the current collector.

2. The battery end plate of claim 1, further comprising an adhesive material attaching the current collector to the interior face of the cap.

3. The battery end plate of claim 2, wherein the adhesive material is a tape that forms a seal between the current collector and the interior face of the cap.

4. The battery end plate of claim 2, wherein the adhesive material and the current collector are positioned within a collector recess defined by a cap alignment frame of the cap.

5. The battery end plate of claim 4, wherein the cap alignment frame extends beyond the current collector in the longitudinal direction.

6. The battery end plate of claim 1, further comprising a solder material positioned in the passageway between the terminal and the tab and electrically connecting the terminal and the tab.

7. The battery end plate of claim 1, wherein the terminal has a raceway formed as a groove in an outer surface of the terminal.

8. The battery end plate of claim 7, wherein the raceway has a portion positioned within the passageway and an insertion end connected with the portion positioned within the passageway, the insertion end is exposed above the top side of the cap.

9. The battery end plate of claim 7, further comprising a sealant material distributed within the raceway and sealing between the terminal and the cap.

10. The battery end plate of claim 1, wherein the cap has a standoff extending from a bottom surface of the passageway in the vertical direction.

11. The battery end plate of claim 10, wherein the tab is positioned on the standoff between a bottom end of the terminal and the standoff in the vertical direction.

12. The battery end plate of claim 1, wherein the tab extends approximately at a right angle from the current collector.

13. The battery end plate of claim 1, further comprising a sealant material filling the passageway between the terminal and the cap.

14. A method of forming a battery end plate, comprising:
providing a cap having an interior face, an exterior face opposite the interior face, and a top side extending between the interior face and the exterior face, a passageway extends in a vertical direction into the top side, a slot extends in a longitudinal direction perpendicular to the vertical direction into the interior face, the passageway communicates with the slot between the interior face and the exterior face;
positioning a current collector on the interior face, the current collector has a tab that extends into the slot; and
inserting a terminal into the passageway, the terminal is electrically connected with the tab of the current collector.

15. The method of claim 14, further comprising heating the terminal before inserting the terminal into the passageway.

16. The method of claim 15, further comprising positioning a solder material on the tab in the passageway before inserting the terminal into the passageway, the terminal melts the solder material to form the electrical connection between the terminal and the tab.

17. The method of claim 14, further comprising filling the passageway with a sealant material between the terminal and the cap, the sealant material flows into a raceway formed as a groove in an outer surface of the terminal.

18. The method of claim 17, wherein the raceway has a portion positioned within the passageway and an insertion end connected with the portion positioned within the passageway, the insertion end is exposed above the top side of the cap and the sealant material is injected into the raceway at the insertion end.

19. The method of claim 14, further comprising attaching the current collector to the interior face of the cap with an adhesive material, the adhesive material forms a seal between the current collector and the interior face.

20. A battery, comprising:
a pair of battery end plates, each of the battery end plates including:
a cap having an interior face, an exterior face opposite the interior face, and a top side extending between the interior face and the exterior face, a passageway extends in a vertical direction into the top side, a slot extends in a longitudinal direction perpendicular to the vertical direction into the interior face, the passageway communicates with the slot between the interior face and the exterior face;
a current collector having a tab, the current collector is disposed on the interior face and the tab extends into the slot; and
a terminal disposed in the passageway and electrically connected with the tab of the current collector; and
a plurality of bipolar plates disposed between the battery end plates.
